(19) United States
(12) Patent Application Publication
(10) Pub. No.: US 2010/0321310 A1
(43) Pub. Date: Dec. 23, 2010

(54) BRIGHTNESS CONTROLLABLE ELECTROLUMINESCENCE DEVICE WITH TACTILE SENSOR SENSING INTENSITY OF FORCE OR INTENSITY OF PRESSURE, FLAT PANEL DISPLAY HAVING THE SAME, MOBILE TERMINAL KEYPAD HAVING THE SAME AND METHOD OF OPERATING THE SAME

(75) Inventors: Jong Ho Kim, Daejeon (KR); Min Seok Kim, Daejeon (KR); Yon-Kyu Park, Daejeon (KR); Dae Im Kang, Daejeon (KR)

Correspondence Address: AKERMAN SENTERFITT, P.O. BOX 3188, WEST PALM BEACH, FL, 33402-3188, US

(73) Assignee: Korea Research Institute of Standards and Science, Yuseong-gu (KR)

(21) Appl. No.: 12/622,077

(22) Filed: Nov. 19, 2009

(30) Foreign Application Priority Data
Jun. 23, 2009 (KR) 10-2009-0055818

(51) Int. Cl. G06F 3/041; G09G 3/30

(52) U.S. Cl. 345/173; 345/77

(57) ABSTRACT

Disclosed herein is an electroluminescence device capable of controlling the brightness thereof based on the intensity of force or the intensity of pressure. The electroluminescence device includes a substrate at least a part of which is transparent; a first electrode formed on the bottom face of the substrate; an emission layer formed underneath the first electrode; a second electrode formed underneath the emission layer; a tactile sensor formed underneath the second electrode and sensing the intensity of force or the intensity of pressure; and a controller connected to the tactile sensor and adjusting a variation in electric field between the first and second electrodes based on the output of the tactile sensor to control the brightness of light emitted from the emission layer.

### BACKGROUND OF THE INVENTION

1. Field of the Invention

The present invention relates to control of the brightness of an electroluminescence device used for a display apparatus or a mobile terminal keypad. More particularly, the invention relates to a brightness controllable electroluminescence device with a tactile sensor sensing the intensity of force or the intensity of pressure.

2. Background of the Related Art

Recently, a variety of flat panel display devices having reduced weights and volumes, different from a cathode ray tube (CRT) having considerable weight and volume, have been developed. These flat panel display devices include a liquid crystal display (LCD), a field emission display, a plasma display panel and an electroluminescence display device.

Among the flat panel display devices, the electroluminescence display device uses electroluminescence. Although electroluminescence has been actively applied to specific fields such as illumination and back lighting since it was discovered by Destriau in 1936, its application is restricted to a very narrow field due to brightness and lifetime. However, the possibility of application to various fields is proposed according to continuous technical research and development. Particularly, an inorganic electroluminescence device that provides uniform plane light, has flexibility and compactness and is insensitive to temperature variation is actively used as a backlight device of a current cellular phone keypad.

In general, electroluminescence devices emit light by applying electric field to a fluorescent compound and are classified into an organic electroluminescence device and an organic electroluminescence device according to the material used for an emission layer.

FIGS. 1, 2 and 3 illustrate conventional inorganic and organic electroluminescence devices. FIG. 1 is a cross-sectional view of a thin-film type inorganic electroluminescence device 100 manufactured according to a conventional technique. The thin-film type inorganic electroluminescence device 100 has a typical stacked structure as shown in FIG. 1. A first electrode 102 is formed of transparent ITO (Indium Tin Oxide) on the bottom face of a substrate 101 and a first insulating layer 103 is formed underneath the first electrode 102. If the thin-film type inorganic electroluminescence device 100 requires flexibility, a transparent plastic material composed of a PET (Poly Ethylene Terephtahalate) film and ITO deposited thereon is generally used for a front transparent substrate. Furthermore, an inorganic emission layer 104 in which electroluminescence occurs is formed underneath the first insulating layer 103 and a second insulating layer 105 and a second electrode 106 are sequentially formed underneath the inorganic emission layer 104. This stacked structure is isolated from the outside according to a protective layer 107 formed underneath the second electrode 106.

In the aforementioned thin-film type inorganic electroluminescence device 100 that is driven by AC, electrons accelerated by a high electric field collide with fluorescence centers and excited. Accordingly, it is required to accelerate a large amount of electrons with high energy in order to achieve high brightness.

In addition, there are dispersion type electroluminescence devices and DC driven electroluminescence devices. An AC driven dispersion type inorganic electroluminescence device (not shown) uses an inorganic emission layer that is formed by dispersing phosphor powder in an organic binder and has a thickness in the range of 50 to 100 μm and uses ZnS as the parent of the phosphor powder. Further, Cu, Ci, I or Mn atoms are added as an activator corresponding to luminescence centers to obtain various emitting colors. Moreover, a DC driven dispersion type electroluminescence device (not shown) uses an inorganic emission layer that is formed of a mixture of ZnS:Cu, Mn phosphor powder and a small amount of organic binder and has a thickness in the range of 30 to 50 μm.

FIG. 2 is a cross-sectional view of a conventional passive matrix organic electroluminescence device 200. Organic electroluminescence devices can be classified into a top-emission type organic electroluminescence device and a bottom-emission type organic electroluminescence device according to a light emission direction and divided into a passive matrix organic electroluminescence device and an active matrix organic electroluminescence device according to a driving method.

The passive matrix organic electroluminescence device 200 shown in FIG. 2 includes a first electrode (anode) 202, a second electrode (cathode) 208 formed under a substrate 201, an organic emission layer 205 formed between the first and second electrodes 202 and 208, and a protective layer 209 packaging the organic emission layer 205. Further, an electron transport layer 206 and an electron injection layer 207 are formed beneath the organic emission layer 205 and a hole transport layer 204 and a hole injection layer 203 are formed on the organic emission layer 205. The organic electroluminescence device 200 is easily degraded according to hydrogen and oxygen, and thus it requires the protective layer 209 formed through an encapsulation process using a sealant such as epoxy resin.

In the active matrix organic electroluminescence device (not shown) among the organic electroluminescence devices, a signal is provided to a plurality of sub-pixels arranged in a matrix and transistors, capacitors and organic LEDs (Light Emitting Diodes) located inside the sub-pixels are driven to display an image.

FIG. 3 is a conceptional view showing the light emission principle of the organic electroluminescence device shown in FIG. 2. Referring to FIG. 3, when a voltage is applied across the anode and the cathode, electrons generated from the cathode move to the organic emission layer 205 through the electron injection layer 207 and the electron transport layer 206. Further, holes generated from the anode move to the organic emission layer 205 through the hole injection layer 203 and the hole transport layer 204. Accordingly, the electrons supplied from the electron transport layer 206 and the holes supplied from the hole transport layer 204 are combined to generate exiton in the organic emission layer 205, and the exiton is excited to the ground state to emit light with predetermined energy through the anode to thereby display an image. The organic emission layer 205 may use a low molecular or high molecular organic material and, when the low molecular organic material is used, the hole injection layer 203, the hole transport layer 204, the organic emission layer 205, the electron transport layer 206 and the electron injection layer 207 can be laminated in a single or composite structure.

In addition to the electroluminescence devices shown in FIGS. 1, 2 and 3, there may be electroluminescence devices in various forms. However, displays or keypad lighting devices employing the electroluminescence devices adopt an ON/OFF emission method and cannot continuously adjust brightness. There was no attempt to produce a brightness controllable device and, even if the brightness controllable device is implemented, the volumes of displays and keypads of mobile terminals and various display devices increase when they employ the brightness controllable device. Accordingly, there is needed a technique capable of easily controlling and achieving brightness a user wants for display devices and lighting devices that are continuously being developed.

### SUMMARY OF THE INVENTION

Accordingly, the present invention has been made in view of the above-mentioned problems occurring in the prior art, and it is a primary object of the present invention to provide a brightness controllable electroluminescence device with a tactile sensor sensing the intensity of force or the intensity of pressure, which is applied to a mobile terminal display, a keypad lighting device and a lighting device for advertisement.

It is a second object of the present invention to provide a brightness controllable electroluminescence device with a tactile sensor sensing the intensity of force or the intensity of pressure for providing emotional feeling together with analog feeling through continuous brightness variation and easily controlling brightness in displays and keypads of various terminals, lighting devices for advertisement and robots.

It is a third object of the present invention to provide a brightness controllable electroluminescence device with a tactile sensor sensing the intensity of force or the intensity of pressure for saving energy through appropriate brightness control.

To accomplish the above objects of the present invention, according to the present invention, there is provided a brightness controllable electroluminescence device with a tactile sensor sensing the intensity of force or the intensity of pressure, which includes a substrate at least a part of which is transparent; a first electrode formed on the bottom face of the substrate; an emission layer formed underneath the first electrode; a second electrode formed underneath the emission layer; a tactile sensor formed on the second electrode and sensing the intensity of force or the intensity of pressure; and a controller connected to the tactile sensor and adjusting a variation in electric field between the first and second electrodes based on the output of the tactile sensor to control the brightness of light emitted from the emission layer.

The brightness controllable electroluminescence device with a tactile sensor sensing the intensity of force or the intensity of pressure may further include at least one of a first insulating layer interposed between the emission layer and the first electrode and a second insulating layer interposed between the emission layer and the second electrode.

The emission layer may be an inorganic emission layer formed of an organic binder and phosphor powder dispersed in the organic binder.

The inorganic emission layer may have a thickness in the range of 50 to 100 μm.

The emission layer may be an inorganic emission layer formed of an organic binder and phosphor powder mixed with the organic binder.

The inorganic emission layer may have a thickness in the range of 30 to 50 μm.

The emission layer may be an organic emission layer.

The organic emission layer may include a hole transport layer interposed between the first electrode and the organic emission layer; a hole injection layer interposed between the hole transport layer and the first electrode; an electron transport layer interposed between the second electrode and the organic emission layer; and an electron injection layer interposed between the electron transport layer and the second electrode.

There may be multiple first electrode and second electrodes which are arranged in an intersecting manner having the organic emission layer formed between the first electrodes and the second electrodes.

The brightness controllable electroluminescence device with a tactile sensor sensing the intensity of force or the intensity of pressure may further include a barrier for electrically separating the multiple second electrodes from one another.

The brightness controllable electroluminescence device with a tactile sensor sensing the intensity of force or the intensity of pressure may further include a protective layer interposed between the second electrode and the tactile sensor.

The tactile sensor may be combined with the protective layer through printing or bonding.

The tactile sensor may use contact resistance or piezoresistance.

The tactile sensor uses capacitance.

The tactile sensor may use a piezoelectric method.

To accomplish the above objects of the present invention, according to the present invention, there is provided a flat panel display including the electroluminescence device.

To accomplish the above objects of the present invention, according to the present invention, there is also provided a keypad lighting device of a mobile terminal including the electroluminescence device.

According to another aspect of the present invention, there is provided to a method of controlling the brightness of a brightness controllable electroluminescence device with a tactile sensor sensing the intensity of force or the intensity of pressure, which includes a step S100 in which at least one of contact resistance of a tactile sensor, piezoresistance of a tactile sensor, capacitance of a tactile sensor and piezoelectric voltage of a tactile sensor, which correspond to the intensity of force or the intensity of pressure applied by a predetermined contact object 1 to a substrate at least a part of which is transparent, is varied; a step S200 in which the output of the tactile sensor is varied based on the variation in the at least one of the contact resistance, the piezoresistance, the capacitance and the piezoelectric voltage; a step S300 in which a controller changes electric field between first and second electrodes arranged having an emission layer formed between the fist and second electrodes based on the variation in the output of the tactile sensor; and a step S400 of controlling the brightness of light emitted from the emission layer based on the electric field variation.

As described above, the present invention can continuously control brightness according to the intensity of force, distinguished from an ink type organic electroluminescence device used for a mobile terminal keypad, which senses only the existence or absence of force and controls brightness in an ON/OFF manner.

Furthermore, the continuous brightness control based on the intensity of force can provide analog feeling and convenience to users when the users use displays and keypads of various terminals and advertisement lighting devices to which the electroluminescence device of the present invention is applied.

Moreover, a partially brightening function is added to a tactile sensor capable of sensing force according to multi-touch by touch points, and thus a user can control the brightness of a selected region of an electroluminescence device.

In addition, appropriate brightness control can save energy.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a cross-sectional view of an AC driven thin-film type inorganic electroluminescence device having a typical stacked structure, manufactured through a conventional technique;

FIG. 2 is a cross-sectional view of a conventional passively driven organic electroluminescence device;

FIG. 3 is a conceptional view illustrating light emission principle of the organic electroluminescence device shown in FIG. 2;

FIG. 4 is a block diagram of an electroluminescence device according to the present invention;

FIG. 5 is a cross-sectional view of an electroluminescence device constructed in such a manner that a tactile sensor is attached to the inorganic electroluminescence device shown in FIG. 1 according to an embodiment of the present invention;

FIG. 6 is a cross-sectional view of an electroluminescence device constructed in such a manner that a tactile sensor is attached to the organic electroluminescence device shown in FIG. 2 according to an embodiment of the present invention;

FIG. 7 is a cross-sectional view of a contact resistance tactile sensor according to an embodiment of the present invention;

FIG. 8 is a perspective view of a conventional slim cellular phone with an organic electroluminescence device attached to a keypad thereof;

FIG. 9 is an exploded perspective view of a cellular phone with a keypad having an organic electroluminescence device combined with the contact resistance tactile sensor according to an embodiment of the present invention;

FIG. 10 is a perspective view showing an electroluminescence device and tactile sensor, which are attached to the surface of a robot capable of performing UWB (Ultra Wide-Band) communication, according to an embodiment of the present invention; and

FIG. 11 is a flowchart showing an operating method according to an embodiment of the present invention.

### DETAILED DESCRIPTION OF THE PREFERRED EMBODIMENT

### Embodiments

FIG. 4 is a block diagram of a brightness controllable electroluminescence device according to the present invention. The brightness controllable electroluminescence device includes an inorganic/organic electroluminescence device 100 or 200, a tactile sensor 400 sensing the intensity of force or the intensity of pressure, and a controller 300 controlling brightness.

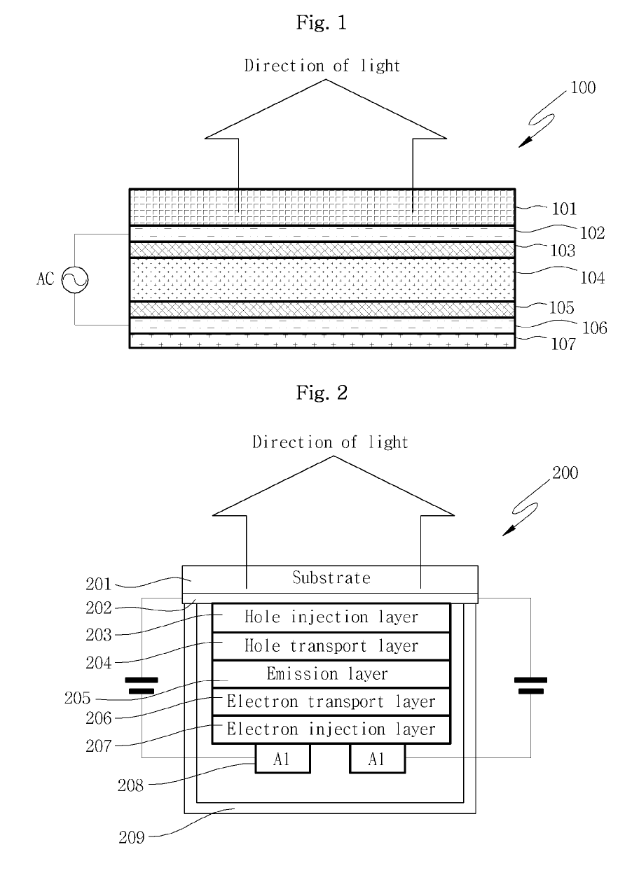

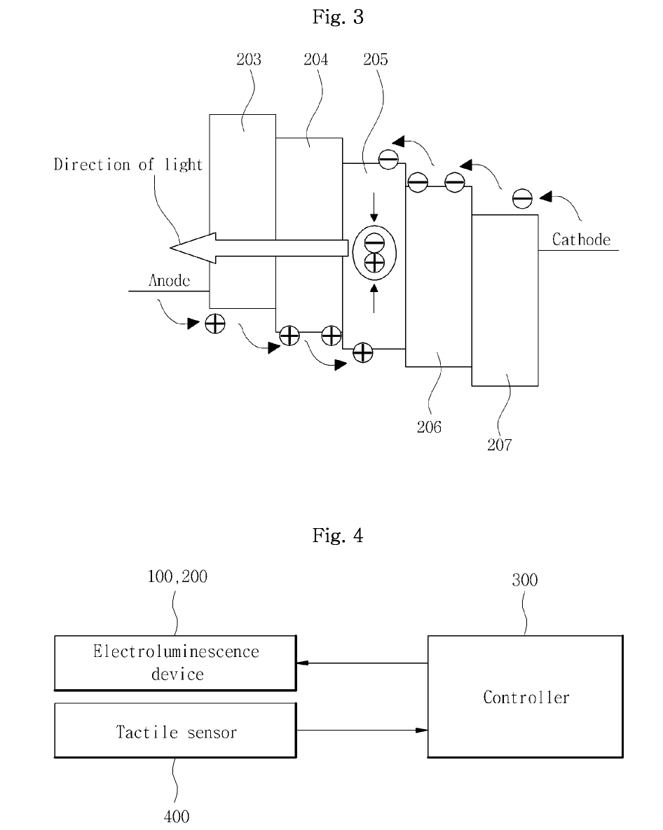

The inorganic/organic electroluminescence device 100 or 200 may be the inorganic electroluminescence device shown in FIG. 1 or the organic electroluminescence device 200 shown in FIG. 2. In addition, the inorganic/organic electroluminescence device 100 or 200 may be selected from various electroluminescence devices as described above. In all the electroluminescence devices, the quantity of flowing electrons is determined by the intensity of electric field and the extent of emission (brightness) can be changed according to the quantity of flowing electrons.

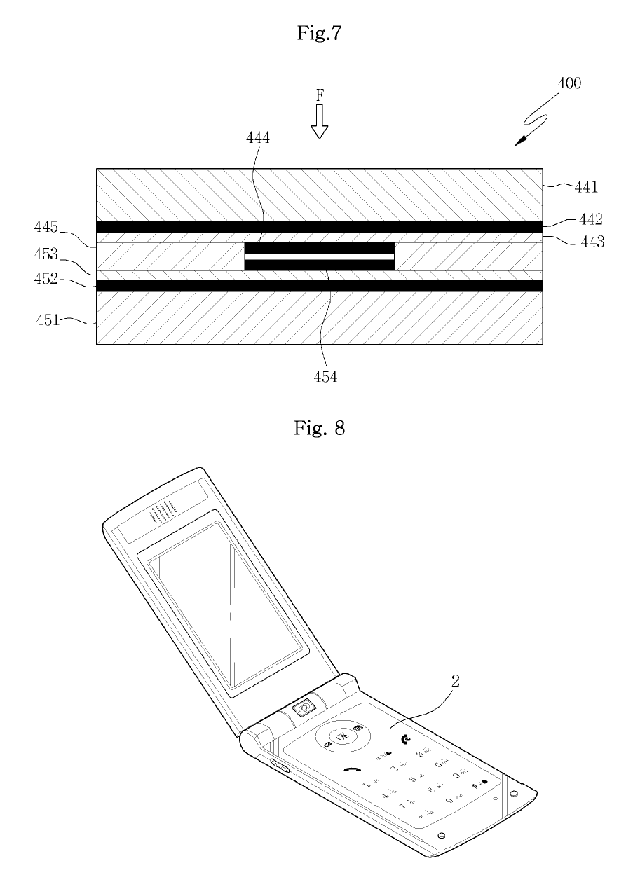

The tactile sensor 400 can sense the intensity of force or the intensity of pressure. In an embodiment of the invention, the contact resistance tactile sensor 400, a capacitance tactile sensor (not shown) and a piezoelectric tactile sensor (not shown) may be used. In addition, any sensor capable of sensing the intensity of force or the intensity of pressure can be used as the tactile sensor 400 of the present invention. The contact resistance tactile sensor 400 according to an embodiment of the present invention will be described later with reference to FIG. 7.

The controller 300 is connected between the electroluminescence device 100 or 200 and the tactile sensor 400 and may be a circuit (not shown) including a variable resistor for controlling output in proportion to the intensity of force or the intensity of pressure. The intensity of force or the intensity of pressure can be varied according to user's touch applied to a substrate, and the output of the tactile sensor 400, which is proportional to the intensity of force or the intensity of pressure, causes a variation in the electric field between the second electrode (cathode) and the first electrode (anode) of the inorganic/organic electroluminescence device 100 or 200. The electric field variation includes the peak value of an AC voltage and a frequency variation and changes the brightness of keypad light.

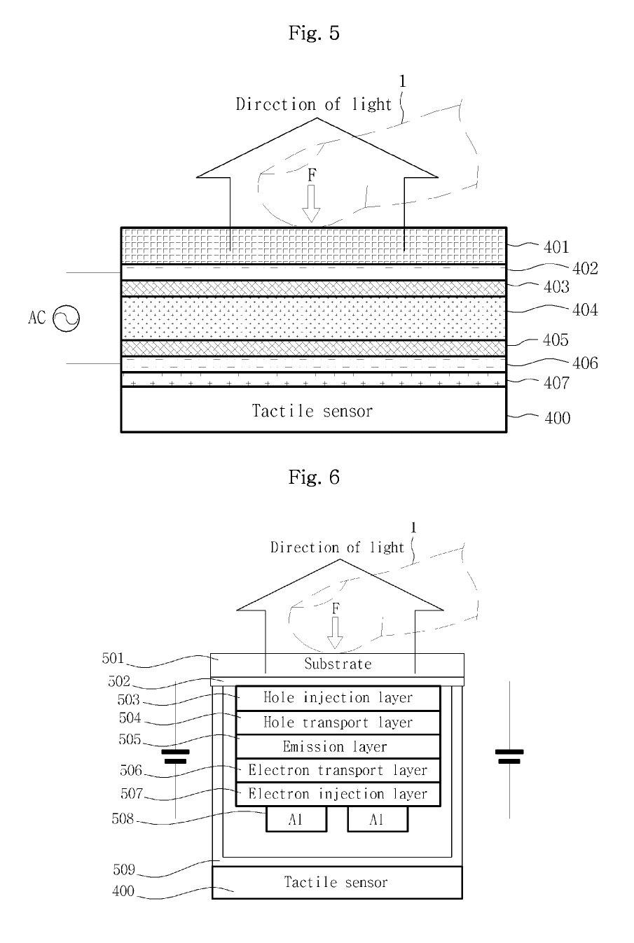

FIG. 5 is a cross-sectional view of an electroluminescence device constructed in such a manner that a tactile sensor is attached to the thin-film type inorganic electroluminescence device shown in FIG. 1 according to an embodiment of the present invention. The thin-film type inorganic electroluminescence device 100 with the tactile sensor 400 includes a substrate 401, a first electrode (anode) 402, a first insulating layer 403, an inorganic emission layer 404, a second insulating layer 405, a second electrode (cathode) 406 and a protective layer 407, which are sequentially formed on the bottom face of the substrate 401, and the tactile sensor 400 formed on the bottom face of the protective layer 407.

A touching force F is applied to the substrate 401 of the thin-film type inorganic electroluminescence device 100 through a contact object 1. The touching force F is transferred to the tactile sensor 400 through the first electrode (anode) 402, the first insulating layer 403, the inorganic emission layer 404, the second insulating layer 405, the second electrode (cathode) 406, and the protective layer 407, which are sequentially laminated. The thickness of the inorganic electroluminescence device 100 with the tactile sensor 400 is merely several hundred μm, and thus the intensity of the touching force F can be transferred to the tactile sensor 400 without being varied. Accordingly, a controller (not shown) adjusts the current between the first electrode (anode) and the second electrode (cathode) of the inorganic electroluminescence device based on the output of the tactile sensor 400 to control the brightness of the inorganic electroluminescence device. Here, the tactile sensor 400 may be formed on the bottom face of the inorganic electroluminescence device through printing or bonding.

FIG. 6 is a cross-sectional view of an electroluminescence device constructed in such a manner that a tactile sensor is attached to the organic electroluminescence device 200 shown in FIG. 2 according to an embodiment of the present invention. Referring to FIG. 6, a first electrode (anode) 502, a hole injection layer 503, a hole transport layer 504, an organic emission layer 505, an electron transport layer 506, an electron injection layer 507 and a second electrode (cathode) 508 are sequentially formed on the bottom face of a substrate 501. Furthermore, the electroluminescence device includes a protective layer 509 and the tactile sensor 400 that is in contact with the protective layer 509 and senses the intensity of force or the intensity of pressure. The path through which the touching force F or pressure corresponding to the touching force is transferred when the touching force F of the contact object 1 is applied to the substrate 501, the principle of controlling brightness and the tactile sensor 400 are identical to those of the electroluminescence device shown in FIG. 5.

### Example of Tactile Sensor

The tactile sensor 400 according to the present invention will now be explained in detail with reference to FIG. 7. FIG. 7 is a cross-sectional view of a contact resistance tactile sensor according to an embodiment of the present invention. The contact resistance tactile sensor 400 includes an upper plate manufactured in such a manner that a coating layer 442 and a metal layer 443 are sequentially formed on a polymer film 441 having a predetermined thickness and a resistor 444 is formed on the metal layer 443, and a lower plate manufactured in such a manner that a coating layer 452 and a metal layer 453 are sequentially formed on a polymer film 451 having a predetermined thickness and a resistor 454 is formed on the metal layer 453. The upper plate and the lower plate are bonded to each other such that the resistor 444 of the upper plate and the resistor 454 of the lower plate face each other having a space 455 formed the resistors 444 and 454.

In addition, the tactile sensor 400 can employ a capacitance tactile sensor (not shown) capable of sensing the intensity of force or the intensity of pressure based on a capacitance variation between electrode layers. Furthermore, the tactile sensor 400 can use a piezoelectric tactile sensor (not shown) capable of sensing the intensity of force or the intensity of pressure based on a piezoelectric voltage variation.

### Application Examples

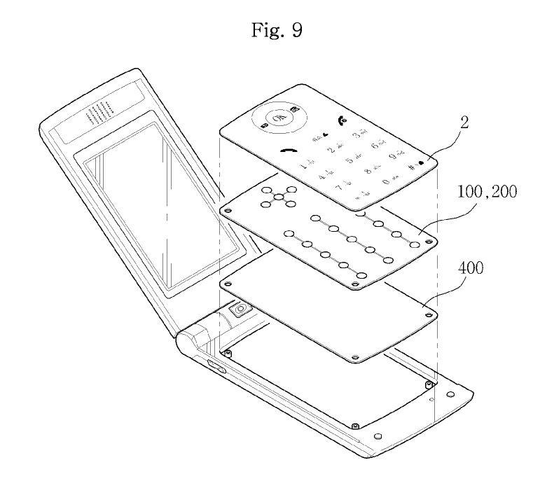

FIG. 8 is a perspective view of a slim cellular phone using a conventional organic electroluminescence device as a keypad lighting device and FIG. 9 is an exploded perspective view of a cellular phone having an organic or inorganic electroluminescence device with the sheet type tactile sensor 400 according to the present invention, which is attached to a keypad of the cellular phone. The cellular phone shown in FIG. 8 has a predetermined brightness irrespective of the intensity of touching force applied to the keypad. In the cellular phone to which the present invention is applied, shown in FIG. 9, touching force or pressure applied to the cellular phone is transferred to the inorganic or organic electroluminescence device 100 or 200 and the tactile sensor 400 located under a keypad cover 2, and thus the brightness can be controlled.

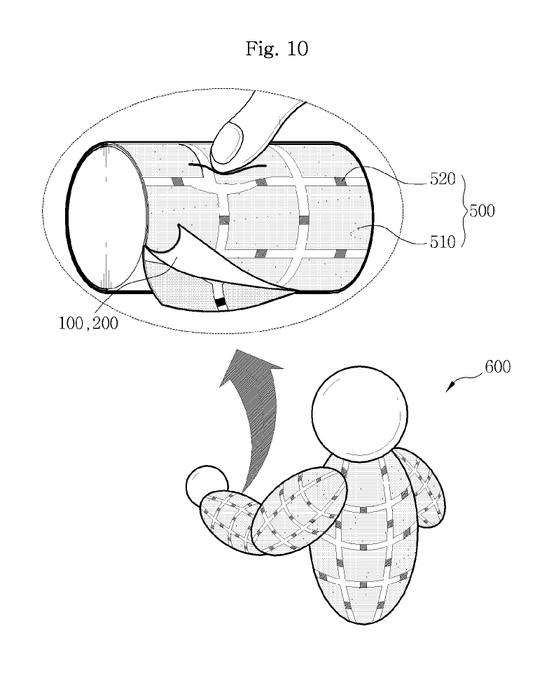

FIG. 10 is a perspective view showing an organic or inorganic electroluminescence device to which a tactile sensor 510 in the form of a sheet is attached, which is attached to the surface of a robot 600. Referring to FIG. 10, the present invention can be applied to the robot 600 including a tactile sensor module 500 for UWB (ultra wide band) wireless communication. Here, the tactile sensor module 500 may include the tactile sensor 510 and an UWB wireless communication means 520. A plurality of tactile sensor modules 500 are connected and attached onto the surface of the robot 600. Accordingly, the brightness of light emitted from the inorganic or organic electroluminescence device 100 or 200 is controlled according to the intensity of force or pressure applied to the robot 600.

<Operating Method>

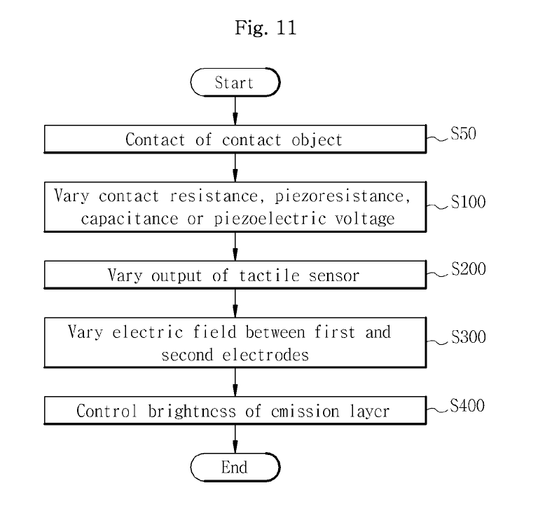

The brightness of the electroluminescence device according to the present invention is controlled according to the following method. The method is explained with reference to FIG. 11. When a predetermined contact object 1 touches a substrate at least a part of which is transparent, and thus the intensity of touching force or the intensity of pressure is applied to the substrate in step S50, at least one of the contact resistance of the tactile sensor 400, piezoresistance of a tactile sensor, capacitance of a tactile sensor or piezoelectric voltage of a tactile sensor, which corresponds to the intensity of touching force or the intensity of pressure, is varied in step S100. Accordingly, the output of the tactile sensor 400 increase or decreases in step S200, and the controller 300 changes the electric field between first and second electrodes arranged' having an emission layer formed between the first and second electrodes based on a variation in the output of the tactile sensor 400 in step S300.

Subsequently, the brightness of light emitted from the emission layer varies with the electric field variation in step S400. Consequently, the brightness of the electroluminescence device according to the present invention is controlled according to a variation in the intensity of touching force or the intensity of pressure of the contact object 1.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A brightness controllable electroluminescence device with a tactile sensor sensing the intensity of force or the intensity of pressure, comprising:
a substrate at least a part of which is transparent;
a first electrode formed on the bottom face of the substrate;
an emission layer formed underneath the first electrode;
a second electrode formed underneath the emission layer;
a tactile sensor formed underneath the second electrode and sensing the intensity of force or the intensity of pressure; and
a controller connected to the tactile sensor and adjusting a variation in electric field between the first and second electrodes based on the output of the tactile sensor to control the brightness of light emitted from the emission layer.

2. The brightness controllable electroluminescence device with a tactile sensor sensing the intensity of force or the intensity of pressure of claim 1, further comprising at least one of a first insulating layer interposed between the emission layer and the first electrode and a second insulating layer interposed between the emission layer and the second electrode.

3. The brightness controllable electroluminescence device with a tactile sensor sensing the intensity of force or the intensity of pressure of claim 1, wherein the emission layer is an inorganic emission layer formed of an organic binder and phosphor powder dispersed in the organic binder.

4. The brightness controllable electroluminescence device with a tactile sensor sensing the intensity of force or the intensity of pressure of claim 3, wherein the inorganic emission layer has a thickness in the range of 50 to 100 μm.

5. The brightness controllable electroluminescence device with a tactile sensor sensing the intensity of force or the intensity of pressure of claim 1, wherein the emission layer is an inorganic emission layer formed of an organic binder and phosphor powder mixed with the organic binder.

6. The brightness controllable electroluminescence device with a tactile sensor sensing the intensity of force or the intensity of pressure of claim 1, wherein the inorganic emission layer has a thickness in the range of 30 to 50 μm.

7. The brightness controllable electroluminescence device with a tactile sensor sensing the intensity of force or the intensity of pressure of claim 1, wherein the emission layer is an organic emission layer.

8. The brightness controllable electroluminescence device with a tactile sensor sensing the intensity of force or the intensity of pressure of claim 7, wherein the organic emission layer comprises:
a hole transport layer interposed between the first electrode and the organic emission layer;
a hole injection layer interposed between the hole transport layer and the first electrode;
an electron transport layer interposed between the second electrode and the organic emission layer; and
an electron injection layer interposed between the electron transport layer and the second electrode.

9. The brightness controllable electroluminescence device with a tactile sensor sensing the intensity of force or the intensity of pressure of claim 7, wherein there are multiple first electrode and second electrodes which are arranged in an intersecting manner having the organic emission layer formed between the first electrodes and the second electrodes.

10. The brightness controllable electroluminescence device with a tactile sensor sensing the intensity of force or the intensity of pressure of claim 1, further comprising a protective layer interposed between the second electrode and the tactile sensor.

11. The brightness controllable electroluminescence device with a tactile sensor sensing the intensity of force or the intensity of pressure of claim 10, wherein the tactile sensor is combined with the protective layer through printing or bonding.

12. The brightness controllable electroluminescence device with a tactile sensor sensing the intensity of force or the intensity of pressure of claim 1, wherein the tactile sensor uses contact resistance or piezoresistance.

13. The brightness controllable electroluminescence device with a tactile sensor sensing the intensity of force or the intensity of pressure of claim 1, wherein the tactile sensor uses capacitance.

14. The brightness controllable electroluminescence device with a tactile sensor sensing the intensity of force or the intensity of pressure of claim 1, wherein the tactile sensor uses a piezoelectric method.

15. A flat panel display comprising the electroluminescence device according to claim 1.

16. A keypad lighting device of a mobile terminal comprising the electroluminescence device according to claim 1.

17. A method of controlling the brightness of a brightness controllable electroluminescence device with a tactile sensor sensing the intensity of force or the intensity of pressure, the method comprising:
a step S100 in which at least one of contact resistance of a tactile sensor, piezoresistance of a tactile sensor, capacitance of a tactile sensor and piezoelectric voltage of a tactile sensor, which correspond to the intensity of force or the intensity of pressure applied by a predetermined contact object 1 to a substrate at least a part of which is transparent, is varied;
a step S200 in which the output of the tactile sensor is varied based on the variation in the at least one of the contact resistance, the piezoresistance, the capacitance and the piezoelectric voltage;
a step S300 in which a controller changes electric field between first and second electrodes arranged having an emission layer formed between the fist and second electrodes based on the variation in the output of the tactile sensor; and
a step S400 of controlling the brightness of light emitted from the emission layer based on the electric field variation.
